(19) United States
(12) Patent Application Publication
(10) Pub. No.: US 2011/0145555 A1
(43) Pub. Date: Jun. 16, 2011

(54) Controlling Power Management Policies on a Per Partition Basis in a Virtualized Environment

(75) Inventors: Naresh Nayar, Rochester, MN (US); Karthick Rajamani, Austin, TX (US); Freeman L. Rawson, III, Austin, TX (US); Todd J. Rosedahl, Zumbrota, MN (US); Malculm S. Ware, Austin, TX (US)

(73) Assignee: International Business Machines Corporation, Armonk, NY (US)

(21) Appl. No.: 12/637,808

(22) Filed: Dec. 15, 2009

(51) Int. Cl. G06F 1/26; G06F 12/00; G06F 12/02; G06F 15/177

(52) U.S. Cl. 713/1; 711/173; 713/340

(57) ABSTRACT

A mechanism is provided for controlling power management policies on a per logical partition basis. A power management mechanism in a data processing system receives a notification that the logical partition has been generated, a set of processing units associated with the logical partition, and a current power management policy to be implemented for the logical partition. The power management mechanism adds the logical partition and the set of processing units to a list of logical partitions. The power management mechanism initializes the set of processing units based on settings for the set of processing units in the current power management policy. The power management mechanism notifies a virtualization mechanism that the set of processing units are running at a specified performance level in order for the logical partition to start executing tasks on the set of processing units.

### BACKGROUND

The present application relates generally to an improved data processing apparatus and method and more specifically to mechanisms for controlling power management policies on a per partition basis in a virtualized environment.

In current computing systems, the density of the number of processor cores is growing at the chip level and, thus, is growing at the server level. With the growth in the number of processor cores, the likelihood is high that a server will run a hypervisor in its lifetime to virtualize the physical cores and consolidate multiple servers onto one. Today, only about 10 percent of servers are virtualized, but momentum is growing to consolidate servers in data centers so that floor space is reduced, less electricity is consumed, both peak and average power, and physical wiring and networking between servers is minimized.

One topic gaining more attention lately in data centers as a benefit from virtualization is a reduction in both peak and average power or electrical demand. Extreme focus has been placed on peak power due to many data centers already being maxed out on available peak power. This focus is due to metropolitan areas being unable to deliver any more megawatts and owners of data centers being reticent to invest more in a new data center if a bit more compute power may be squeezed from their existing data centers. One solution being used is to virtualize a number of older servers' workloads onto a single, new consolidation server, resulting in a net reduction in peak electrical demand.

Most older and smaller servers are underutilized such that the older server may only be running a single operating system (OS) and, most likely, a single application. Typical utilization levels for these smaller servers are 7 to 9 percent. While smaller servers often achieve very high Standard Performance Evaluation Corporation (SPEC) power (SPECpower) scores, the smaller servers obfuscate their ultimate shortfall, namely, very little Dynamic Random Access Memory (DRAM) and memory bandwidth, which is usually only sufficient performance and capacity to run a single application. Additionally, just powering on these smaller servers is a net loss because the base power, even when idling these machines, is too expensive for such low utilization levels. That is, just to power on a smaller server usually draws 200 to 300 Watts, typically.

However, larger servers also have an apparent disadvantage. That is, larger servers do poorly on SPECpower mainly due to the support required to provide capacity and performance for DRAM and have poor idle power characteristics. The real advantage of larger servers is that, by running a hypervisor in combination with much larger DRAM capacity and performance, workload consolidation from many smaller servers is practical. For example, in one example, six smaller servers may be consolidated onto one large server, thereby raising utilization to 25 to 35 percent. In this example, it takes only 800 Watts just to turn on the large server and run at an idle state. At 35 percent utilization, the larger server draws 1000 Watts. By contrast, the 6 individual smaller servers draw 1200 to 1800 Watts at their 7 to 9 percent utilization, resulting in a significant reduction in peak electrical demand.

### SUMMARY

In one illustrative embodiment, a method, in a data processing system, is provided for controlling power management policies on a per logical partition basis. The illustrative embodiment receives a notification that the logical partition has been generated, a set of processing units associated with the logical partition, and a current power management policy to be implemented for the logical partition. The illustrative embodiment adds the logical partition and the set of processing units to a list of logical partitions. The illustrative embodiment initializes the set of processing units based on settings for the set of processing units in the current power management policy. The illustrative embodiment notifies a virtualization mechanism in the data processing system that the set of processing units are running at a specified performance level as specified by the settings for the set of processing units in the current power management policy in order for the logical partition to start executing tasks on the set of processing units.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a block diagram of a data processing system with which aspects of the illustrative embodiments may advantageously be utilized;

FIG. 2 depicts a block diagram of an exemplary logically partitioned platform in which the illustrative embodiments may be implemented;

FIG. 3 depicts an exemplary block diagram illustrating a data processing system with a virtualized environment in accordance with an illustrative embodiment;

FIG. 4 depicts an example of the operation performed by a partition creation mechanism in a virtualized environment in accordance with an illustrative embodiment;

FIG. 5 depicts an example of the operation performed by a virtualization layer in a virtualized environment in accordance with an illustrative embodiment;

FIG. 6 depicts an example of the operation performed by a power management mechanism in a virtualized environment in accordance with an illustrative embodiment; and

FIG. 7 depicts an example of the operation performed by an active energy manager mechanism in a virtualized environment in accordance with an illustrative embodiment.

### DETAILED DESCRIPTION

Virtualization provides an opportunity to reduce peak and average power demand as outlined in background. However, the ultimate goal is to reduce peak and average power demand through a combination of virtualization and Dynamic Power Performance Management (DPPM). DPPM is critical to minimize the final peak and average power consumption of a consolidated server. That is, without DPPM a 35% utilized server will only draw a small percent less power than a 100 percent utilized server. Each consolidated workload in a virtualized environment has different power performance needs. Some modern servers turn off DPPM because DPPM may interfere with meeting quality of service or performance guarantees based on the workload type. Thus, the problem is how to set DPPM policies on a per partition basis and offer full flexibility of DPPM power performance tradeoffs in the presence of a virtualized environment. To properly enable DPPM in a virtualized server, the underlying power management firmware needs to be fully aware of how the DPPM policy maps to whatever physical processor cores are performing the computing for a specific partition.

The illustrative embodiments provide a mechanism for controlling power management policies on a per partition basis in a virtualized environment. In the illustrative embodiments, a logical interaction is provided between four key components: a mechanism that can set DPPM policies on a per partition basis, a mechanism that knows about partitions and associated DPPM policies per partition, a mechanism that generates or destroys partitions, and a mechanism that is responsible for making pools of physical cores available to run partitions. Using this logical interaction between the four key components, power management policies may be controlled on a per partition basis.

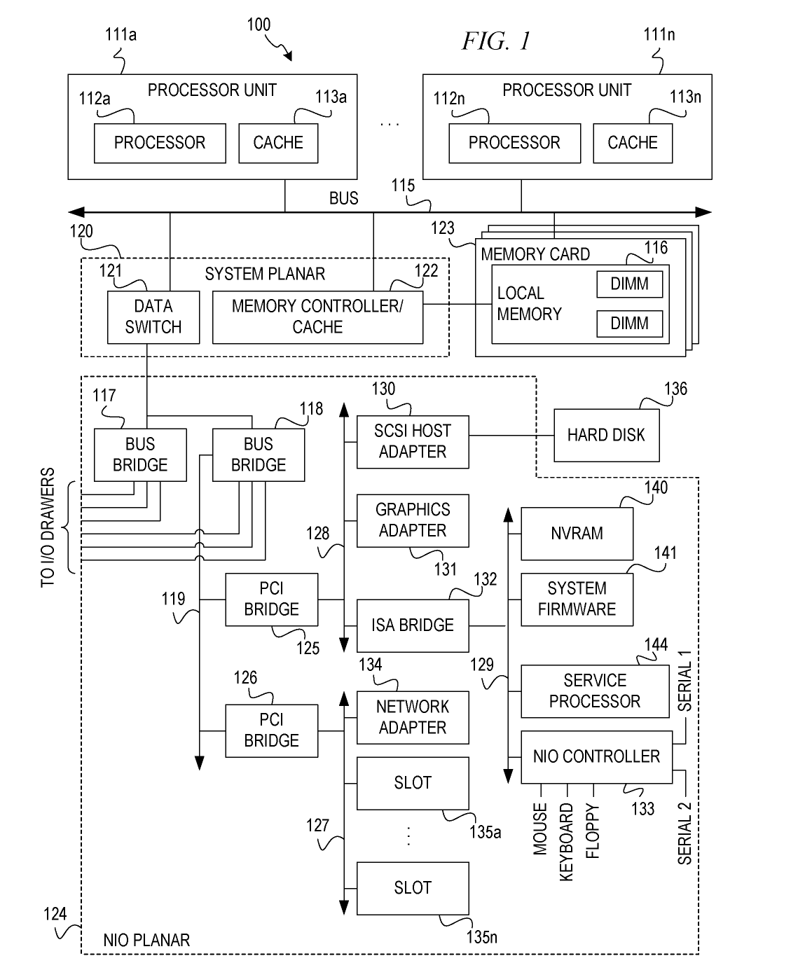

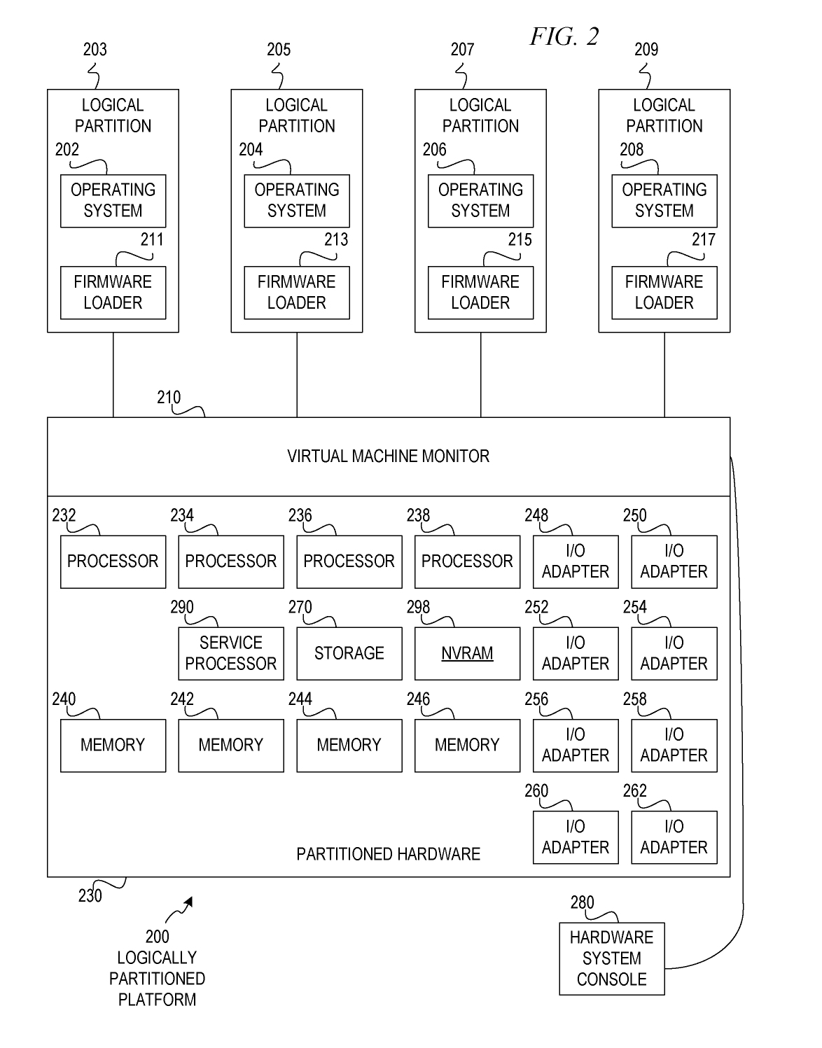

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation for controlling power management policies on a per partition basis in a virtualized environment, this is only an example and is not intended to state or imply any limitation with regard to the features of the present invention. To the contrary, the illustrative embodiments are intended to include distributed data processing environments and embodiments in which power management policies may be controlled on a per partition basis in a virtualized environment.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

In the illustrative embodiments, a computer architecture is implemented as a combination of hardware and software. The software part of the computer architecture may be referred to as microcode or millicode. The combination of hardware and software creates an instruction set and system architecture that the rest of the computer's software operates on, such as Basic Input/Output System (BIOS), Virtual Machine Monitors (VMM), Hypervisors, applications, etc. The computer architecture created by the initial combination is immutable to the computer software (BIOS, etc), except through defined interfaces which may be few.

Referring now to the drawings and in particular to FIG. 1, there is depicted a block diagram of a data processing system with which aspects of the illustrative embodiments may advantageously be utilized. As shown, data processing system 100 includes processor units 111a-111n. Each of processor units 111a-111n includes a processor and a cache memory. For example, processor unit 111a contains processor 112a and cache memory 113a, and processor unit 111n contains processor 112n and cache memory 113n.

Processor units 111a-111n are connected to main bus 115. Main bus 115 supports system planar 120 that contains processor units 111a-111n and memory cards 123. System planar 120 also contains data switch 121 and memory controller/cache 122. Memory controller/cache 122 supports memory cards 123 that include local memory 116 having multiple dual in-line memory modules (DIMMs).

Data switch 121 connects to bus bridge 117 and bus bridge 118 located within native I/O (NIO) planar 124. As shown, bus bridge 118 connects to peripheral components interconnect (PCI) bridges 125 and 126 via system bus 119. PCI bridge 125 connects to a variety of I/O devices via PCI bus 128. As shown, hard disk 136 may be connected to PCI bus 128 via small computer system interface (SCSI) host adapter 130. Graphics adapter 131 may be directly or indirectly connected to PCI bus 128. PCI bridge 126 provides connections for external data streams through network adapter 134 and adapter card slots 135a-135n via PCI bus 127.

Industry standard architecture (ISA) bus 129 connects to PCI bus 128 via ISA bridge 132. ISA bridge 132 provides interconnection capabilities through NIO controller 133 having serial connections Serial 1 and Serial 2. A floppy drive connection, keyboard connection, and mouse connection are provided by NIO controller 133 to allow data processing system 100 to accept data input from a user via a corresponding input device. In addition, non-volatile RAM (NVRAM) 140, connected to ISA bus 129, provides a non-volatile memory for preserving certain types of data from system disruptions or system failures, such as power supply problems. System firmware 141 is also connected to ISA bus 129 for implementing the initial Basic Input/Output System (BIOS) functions. Service processor 144 connects to ISA bus 129 to provide functionality for system diagnostics or system servicing.

The operating system (OS) is stored on hard disk 136, which may also provide storage for additional application software for execution by a data processing system. NVRAM 140 is used to store system variables and error information for field replaceable unit (FRU) isolation. During system startup, the bootstrap program loads the operating system and initiates execution of the operating system. To load the operating system, the bootstrap program first locates an operating system kernel image on hard disk 136, loads the OS kernel image into memory, and jumps to an initial address provided by the operating system kernel. Typically, the operating system is loaded into random-access memory (RAM) within the data processing system. Once loaded and initialized, the operating system controls the execution of programs and may provide services such as resource allocation, scheduling, input/output control, and data management.

The illustrative embodiment may be embodied in a variety of data processing systems utilizing a number of different hardware configurations and software such as bootstrap programs and operating systems. The data processing system 100 may be, for example, a stand-alone system or part of a network such as a local-area network (LAN) or a wide-area network (WAN). As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary logically partitioned platform is depicted in which the illustrative embodiments may be implemented. The hardware in logically partitioned platform 200 may be implemented, for example, using the hardware of data processing system 100 in FIG. 1.

Logically partitioned platform 200 includes partitioned hardware 230, operating systems 202, 204, 206, 208, and virtual machine monitor 210. Operating systems 202, 204, 206, and 208 may be multiple copies of a single operating system or multiple heterogeneous operating systems simultaneously run on logically partitioned platform 200. These operating systems may be implemented, for example, using OS/400, which is designed to interface with a virtualization mechanism, such as partition management firmware, e.g., a hypervisor. OS/400 is used only as an example in these illustrative embodiments. Of course, other types of operating systems, such as AIX® and Linux®, may be used depending on the particular implementation. Operating systems 202, 204, 206, and 208 are located in logical partitions 203, 205, 207, and 209, respectively.

Hypervisor software is an example of software that may be used to implement platform (in this example, virtual machine monitor 210) and is available from International Business Machines Corporation. Firmware is “software” stored in a memory chip that holds its content without electrical power, such as, for example, a read-only memory (ROM), a programmable ROM (PROM), an erasable programmable ROM (EPROM), and an electrically erasable programmable ROM (EEPROM).

Logical partitions 203, 205, 207, and 209 also include partition firmware loader 211, 213, 215, and 217. Partition firmware loader 211, 213, 215, and 217 may be implemented using IPL or initial boot strap code, IEEE-1275 Standard Open Firmware, and runtime abstraction software (RTAS), which is available from International Business Machines Corporation.

When logical partitions 203, 205, 207, and 209 are instantiated, a copy of the boot strap code is loaded into logical partitions 203, 205, 207, and 209 by virtual machine monitor 210. Thereafter, control is transferred to the boot strap code with the boot strap code then loading the open firmware and RTAS. The processors associated or assigned to logical partitions 203, 205, 207, and 209 are then dispatched to the logical partition's memory to execute the logical partition firmware.

Partitioned hardware 230 includes a plurality of processors 232-238, a plurality of system memory units 240-246, a plurality of input/output (I/O) adapters 248-262, and storage unit 270. Each of the processors 232-238, memory units 240-246, NVRAM storage 298, and I/O adapters 248-262 may be assigned to one of multiple logical partitions 203, 205, 207, and 209 within logically partitioned platform 200, each of which corresponds to one of operating systems 202, 204, 206, and 208.

Virtual machine monitor 210 performs a number of functions and services for logical partitions 203, 205, 207, and 209 to generate and enforce the partitioning of logical partitioned platform 200. Virtual machine monitor 210 is a firmware implemented virtual machine identical to the underlying hardware. Thus, virtual machine monitor 210 allows the simultaneous execution of independent OS images 202, 204, 206, and 208 by virtualizing all the hardware resources of logical partitioned platform 200.

Service processor 290 may be used to provide various services, such as processing of platform errors in logical partitions 203, 205, 207, and 209. Service processor 290 may also act as a service agent to report errors back to a vendor, such as International Business Machines Corporation. Operations of the different logical partitions may be controlled through a hardware system console 280. Hardware system console 280 is a separate data processing system from which a system administrator may perform various functions including reallocation of resources to different logical partitions.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system without departing from the spirit and scope of the present invention.

As stated previously, the issue with known systems is that the underlying power management firmware fail to be fully aware of how Dynamic Power Performance Management (DPPM) policies map to whatever physical processor cores are performing the computing for a specific partition. Thus, the illustrative embodiments properly enable DPPM in a virtualized server by providing a logical interaction between four key components of the virtualized data processing system so that the underlying power management firmware is fully aware of how the DPPM policy maps to whatever physical processor cores are performing the computing for a specific partition.

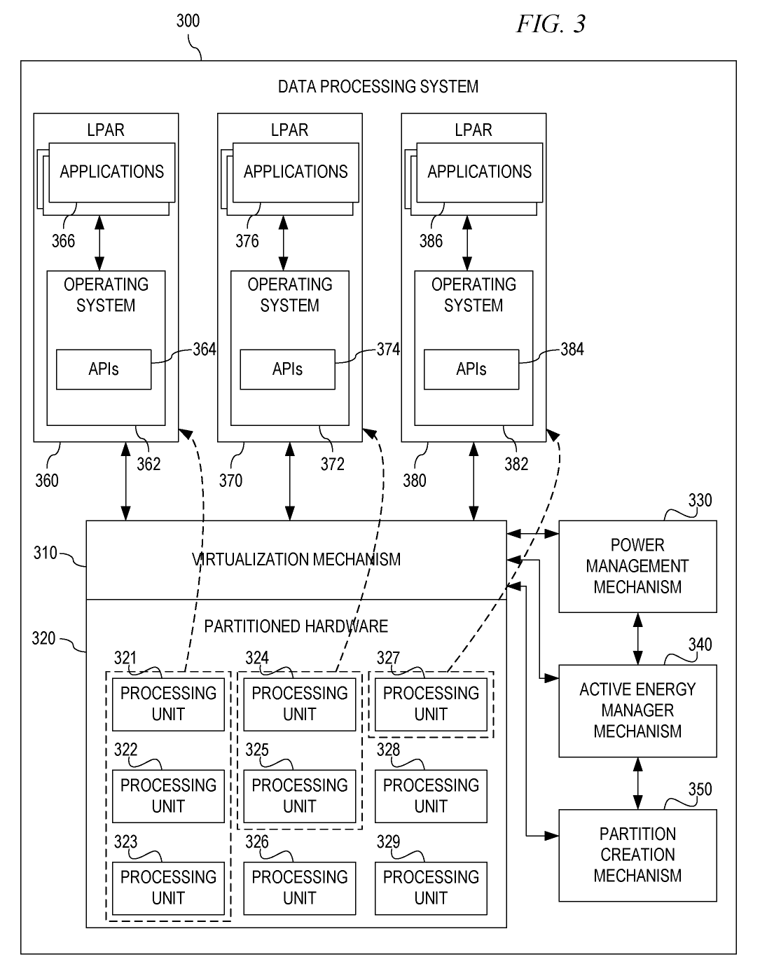

FIG. 3 depicts an exemplary block diagram illustrating a data processing system with a virtualized environment in accordance with an illustrative embodiment. Logically partitioned data processing system 300 comprises virtualization mechanism 310, partitioned hardware 320, power management mechanism 330, active energy manager mechanism 340, and partition creation mechanism 350. Virtualization mechanism 310 may be software that performs communications and resource management between partitioned hardware 320, power management mechanism 330, active energy manager mechanism 340, partition creation mechanism 350, and a plurality of logical partitions (LPARs) 360, 370, and 380. While partitioned hardware 320 is only illustrated as comprising processing units 321-329, other partitioned hardware may be comprised within partitioned hardware 320 as is illustrated in partitioned hardware 230 of FIG. 2. Virtualization mechanism 310 may also perform tasks such as processor time slice sharing, memory allocation, or the like. Virtualization mechanism 310 may be, for example, a hypervisor or a virtual machine monitor, such as virtual machine monitor 210 of FIG. 2.

LPARs 360, 370, and 380 may also be referred to as clients or initiators. LPAR 360 has an instance of an operating system (OS) 362 with a set of application programming interfaces (APIs) 364 and one or more applications 366 running. LPAR 370 has OS 372 with APIs 374 and one or more applications 376. LPAR 380 has OS 382 with APIs 384 and one or more applications 386. While logically partitioned data processing system 300 illustrates only LPARs 360, 370, and 380, the illustrative embodiments are not limited to such. Rather, any number of LPARs may be utilized with the mechanisms of the illustrative embodiments without departing from the spirit and scope of the present invention.

In this example, partition creation mechanism 350 receives one or more logical partition requests for the creation or destruction of logical partitions, such as LPARs 360, 370, and 380, from a user. Upon receiving a creation request, partition creation mechanism 350 identifies in the request the type of logical partition to be generated, such as a dedicated logical partition, a shared logical partition, or the like, a number of processing units, such as processors, processor cores, or the like, that are to be allocated to the logical partition, and whether a Dynamic Power Performance Management (DPPM) policy is specified. While the following description is directed to the creation of a dedicated logical partition and an allocation of processing units in whole units to the dedicated logical partition, the illustrative embodiments are not limited to only this example. That is, one of ordinary skill in the art would recognize that any type of logical partition may be generated and any number of or portion of a processor or processor core, i.e. time-slicing, may be allocated to a logical partition, without departing from the spirit and scope of the invention.

Exemplary DPPM policies may include the following:
A nominal policy in which there is no dynamic power management and all cores in the partition run at the same nominal frequency.
A static power save policy in which all cores in the partition run at a fixed fraction, less than one, of nominal frequency, but frequency is not changed dynamically.
A static turbo boost policy in which all cores in the partition run at a fixed fraction, greater than one, of nominal frequency, but frequency is not changed dynamically unless a power or thermal limit is reached.
A dynamic power save with maximum performance policy that varies the frequencies of all cores in the partition dynamically in response to workload slack or idleness, with the goal of removing all slack in the system such that the work gets done just in time, but allowing the frequencies of cores to go as high as the turbo boost frequency range.
A dynamic power save with a performance floor where frequency is varied continuously for the cores in the partition, while maintaining the performance metric defined by the floor.

The above depicts a variety of DPPM policies; however, the list of DPPM policies is not fully inclusive and other DPPM policies may be used without departing from the spirit and scope of the invention. The important point is to assign the appropriate, unique DPPM policy based on the performance and power needs for each partition's workload and operating system (OS). The type of metrics and algorithms used based on the DPPM policy chosen may be from a potentially very large set covering utilization based techniques, architectural slack detection techniques, memory boundedness techniques, performance floor instructions per second throughput metrics, or latency or quality of service response time metrics to guide the algorithms.

After partition creation mechanism 350 identifies the type of logical partition to be generated and the number of processing units to be allocated to the logical partition, partition creation mechanism 350 generates the logical partition, assigns a logical partition name (LPARname) to the logical partition, and allocates a physical group or pool of processing units to the logical partition. In this example, partition creation mechanism 350 generates LPAR 360 and assigns processing units 321-323 to LPAR 360. Likewise, partition creation mechanism 350 generates LPAR 370 and assigns processing units 324 and 325 to LPAR 370 and partition creation mechanism 350 generates LPAR 380 and assigns processing unit 327 to LPAR 380. After the logical partition is generated, partition creation mechanism 350 sends a signal to virtualization mechanism 310 informing virtualization mechanism 310 of the LPARname of each generated logical partition, a number of processing units assigned to each logical partition, and an initial DPPM policy to be set for each logical partition to a default power performance policy unless the requestor of the logical partition specifies a unique DPPM policy with the request.

The destruction of a logical partition works in a similar fashion. That is, in response to a request for the destruction of a logical partition, partition creation mechanism 350 destroys the logical partition, deallocates any processing units allocated to the logical partition, sends a signal to virtualization mechanism 310 informing virtualization mechanism 310 of the LPARnames of the destroyed logical partitions.

Once virtualization mechanism 310 receives the information from partition creation mechanism 350, virtualization mechanism 310 determines whether the information is for either the creation or the destruction of a logical partition. If the information from partition creation mechanism 350 is for the creation of a logical partition, virtualization mechanism 310 sends a signal to active energy manager mechanism 340 informing active energy manager mechanism 340 of the generated logical partition and the signal also includes the LPARname of the logical partition. Virtualization mechanism 310 also sends a signal to power management mechanism 330 informing power management mechanism 330 of the LPARname of the generated logical partition, the number of processing units assigned to the logical partition, and the current DPPM policy associated with the logical partition. Again, the DPPM policy may be a default power performance policy unless the requestor of the logical partition specifies a unique DPPM policy. If the information from partition creation mechanism 350 is for the destruction of a logical partition, virtualization mechanism 310 sends a signal to active energy manager mechanism 340 and power management mechanism 330 informing active energy manager mechanism 340 and power management mechanism 330 to destroy all information associated with the specified logical partition.

Upon receiving the information from virtualization mechanism 310, power management mechanism 330 determines whether the information is for either the creation or the destruction of a logical partition. If the information from virtualization mechanism 310 is for the creation of a logical partition, power management mechanism 330 adds the new LPARname of the logical partition and physical processing units associated with the logical partition to a list of logical partitions that power management mechanism 330 will apply DPPM policies to. Power management mechanism 330 initializes the processing units associated with the logical partition to a specified performance level associated with the logical partition specified in the DPPM policy settings associated with the logical partition. In the illustrative embodiments, the specified performance level is operating level of the processing units such that the partition may operate without impacting a performance level of the partition. Therefore, the processing units may run at any frequency, power level, or the like, as the DPPM policy may adapt the frequency continuously and still meet a specified performance level by exploiting slack found in the data processing system 300 that may be removed by lowering frequency without negatively impacting the performance level. Once the processing units are running at the specified performance level, power management mechanism 330 sends a signal to virtualization mechanism 310 that informs virtualization mechanism 310 that the processing units associated with the logical partition are successfully running at the specified performance level associated with the current DPPM policy. If for some reason one or more of the processing units fail to initialize properly, power management mechanism 330 may send an error to partition creation mechanism 350 to recreate the partition that failed to initialize properly. If the initialization error occurs more than a predetermined number of times, partition creation mechanism 350 may cease trying to create the partition and send an error back to the user.

Power management mechanism 330 then begins to monitor the active processing units for all logical partitions. Power management mechanism 330 collects data such as operational frequency, processing unit utilization, instructions per second rates, memory hierarchy latency characteristics, power usage, or the like. At either predetermined times, periodic intervals, in response to a query, or the like, power management mechanism 330 sends partition level trending data such as average frequency, average utilization, average power usage, or the like to active energy manager mechanism 340. If the information from the virtualization mechanism 310 is for the destruction of a logical partition, power management mechanism 330 destroys all information associated with the specified logical partition. Power management mechanism 330 may also make the trending data available to the operating system running on the associated partition via virtualization mechanism 310.

As discussed previously, active energy manager mechanism 340 receives information from virtualization mechanism 310 indicating the creation of each logical partition. Using the LPARname for the logical partition included in the information from virtualization mechanism 310, active energy manager mechanism 340 generates or adds to a list of generated logical partitions for the user which are presented to the user that requested the generation of the logical partitions. Upon receiving trending data from power management mechanism 330, active energy manager mechanism 340 associates the received trending data with the associated logical partition. Active energy manager mechanism 340 also presents the trending data to the user. Based on the trending data for the logical partition, the user may adjust the current DPPM policy, whether the DPPM policy is a unique DPPM policy provided at the creation of the logical partition, a previously submitted DPPM policy, or the system default DPPM policy, through active energy manager mechanism 340. If the user makes adjustments to one or more current DPPM policies associated with one or more associated logical partitions generated for the user and submits the adjustments through active energy manager mechanism 340, the adjustments become the new DPPM policy for the associated logical partition. Based on the new DPPM policy, active energy manager mechanism 340 signals virtualization mechanism 310 with the new DPPM policy for the associated logical partition. While the illustrative embodiments depict that the user submits a new DPPM policy based on trending data presented by active energy manager mechanism 340, the user may submit a new DPPM policy at any time and not solely in response to current trending data. Other examples of DPPM policy changes that may be made by the user may include time of day changes in DPPM policies that relate to mitigating peak power draw, cooling needs in data centers, night time operation, or the like.

Upon receiving the new DPPM policy for the logical partition, virtualization mechanism 310 sends a signal to power management mechanism 330 informing power management mechanism 330 of the new DPPM policy associated with the logical partition. Using the new DPPM policy, power management mechanism 330 adjusts parameters associated with the processing units allocated to the logical partition. Once the processing units are running at the new performance level, power management mechanism 330 sends a signal to virtualization mechanism 310 that informs virtualization mechanism 310 that the processing units associated with the logical partition are successfully running at the specified performance level associated with the new DPPM policy and continues monitoring the active processing units for all logical partitions.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

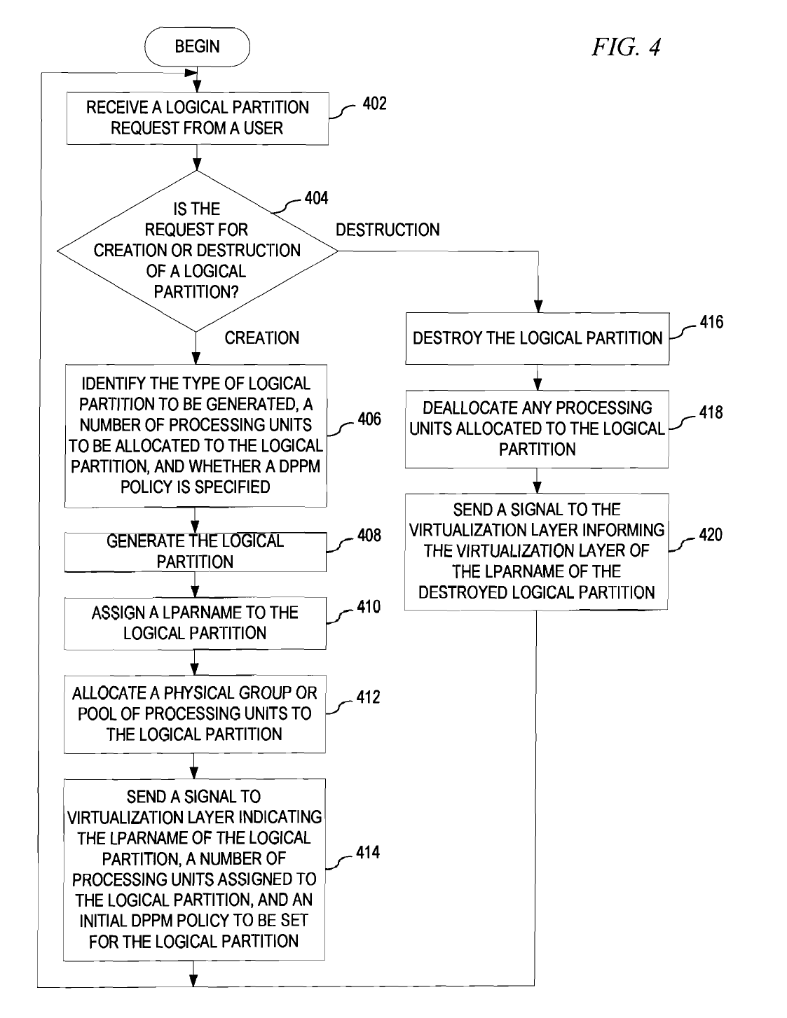

Referring now to FIGS. 4-7, these figures provide flowcharts outlining example operations of controlling power management policies on a per partition basis in a virtualized environment. While the following figures are described in relation to only one logical partition being generated or destroyed, one of ordinary skill in the art would realize that the operation may be performed with any number of logical partitions without departing from the spirit and scope of the invention.

FIG. 4 depicts an example of the operation performed by a partition creation mechanism in a virtualized environment in accordance with an illustrative embodiment. As the operation begins, the partition creation mechanism receives a logical partition request from a user for the creation or destruction of a logical partition (step 402). The partition creation mechanism determines whether the request is for the creation or the destruction of a logical partition (step 404). If at step 404 the request is for the creation of a logical partition, the partition creation mechanism identifies the type of logical partition to be generated, a number of processing units that are to be allocated to the logical partition, and whether a Dynamic Power Performance Management (DPPM) policy is specified (step 406). The logical partition may be a dedicated logical partition, a shared logical partition, or the like.

The partition creation mechanism then generates the logical partition (step 408), assigns a logical partition name (LPARname) to the logical partition (step 410), and allocates a physical group or pool of processing units to the logical partition (step 412). The partition creation mechanism sends a signal to a virtualization layer informing the virtualization layer of the LPARname of the logical partition, a number of processing units assigned to the logical partition, and an initial DPPM policy to be set for the logical partition (step 414), with the operation returning to step 402 thereafter to wait for the next request. Again, the DPPM policy may be a default power performance policy unless the requestor of the logical partition specifies a unique DPPM policy with the request. If at step 404 the request is for the destruction of a logical partition, the partition creation mechanism destroys the logical partition (step 416), deallocates any processing units allocated to the logical partition (step 418), and sends a signal to the virtualization layer informing the virtualization layer of the LPARname of the destroyed logical partition (step 420), with the operation returning to step 402 thereafter to wait for the next request.

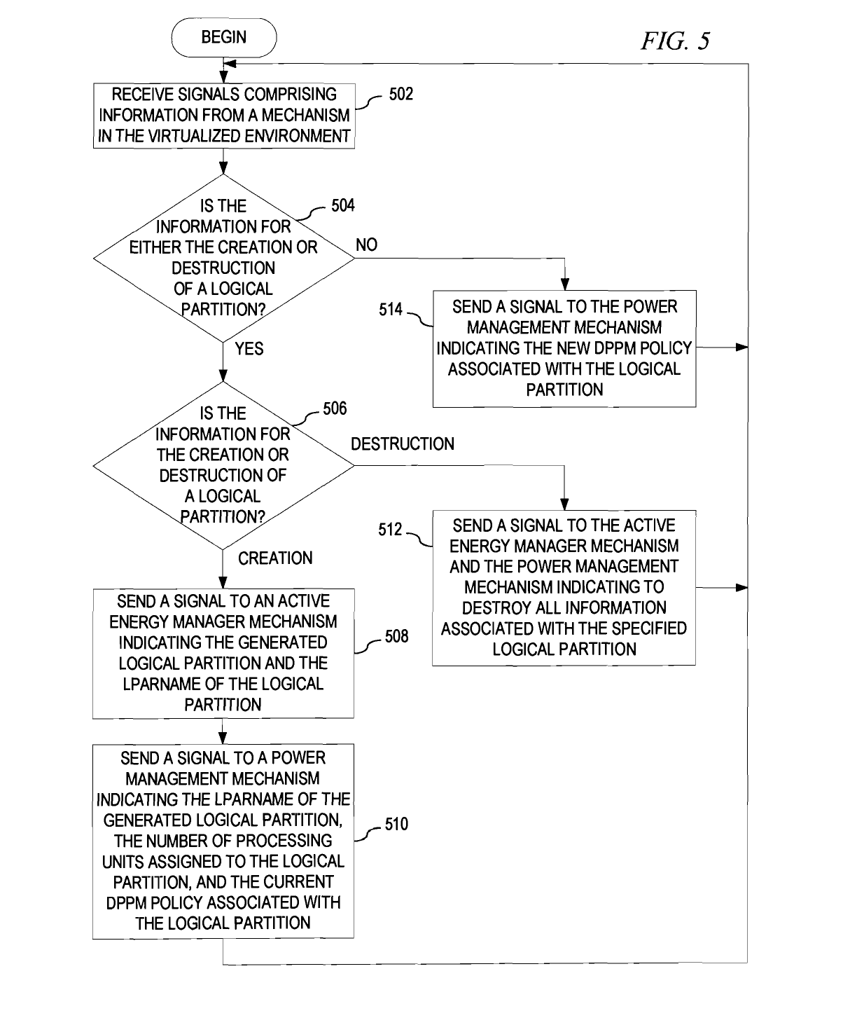

FIG. 5 depicts an example of the operation performed by a virtualization layer in a virtualized environment in accordance with an illustrative embodiment. As the operation begins, the virtualization layer receives signals comprising information from a mechanism in the virtualized environment (step 502). The virtualization layer determines whether the information is for either the creation or the destruction of a logical partition (step 504). If at step 504 the information is for either the creation or the destruction of a logical partition, the virtualization layer determines whether the information is for the creation or the destruction of a logical partition (step 506). If at step 506 the information is for the creation of a logical partition, the virtualization layer sends a signal to the active energy manager mechanism informing the active energy manager mechanism of the generated logical partition and the LPARname of the logical partition (step 508). The virtualization layer also sends a signal to a power management mechanism informing the power management mechanism of the LPARname of the generated logical partition, the number of processing units assigned to the logical partition, and the current DPPM policy associated with the logical partition (step 510), with the operation returning to step 502 thereafter to wait for the next receipt of information.

If at step 506 the information is for the destruction of a logical partition, the virtualization layer sends a signal to the active energy manager mechanism and the power management mechanism informing the active energy manager mechanism and the power management mechanism to destroy all information associated with the specified logical partition (step 512), with the operation returning to step 502 thereafter to wait for the next receipt of information. If at step 504 the information is a new DPPM policy for a logical partition, the virtualization layer sends a signal to the power management mechanism informing the power management mechanism of the new DPPM policy associated with the logical partition (step 514), with the operation returning to step 502 thereafter to wait for the next receipt of information.

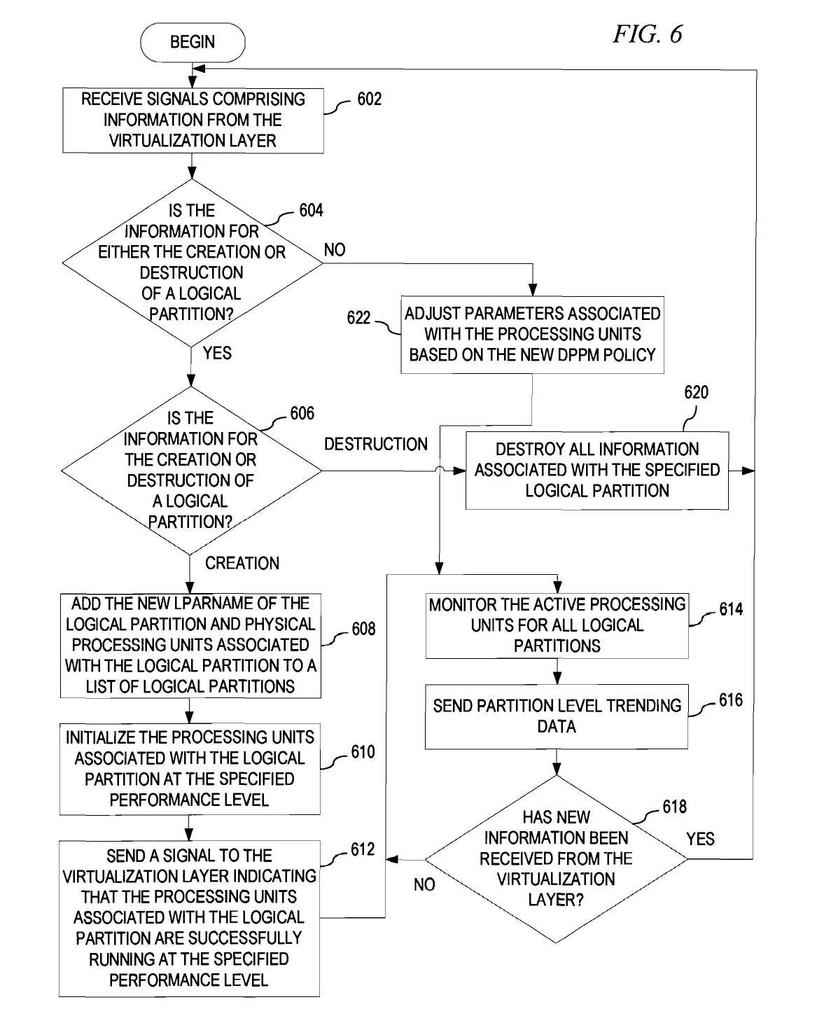

FIG. 6 depicts an example of the operation performed by a power management mechanism in a virtualized environment in accordance with an illustrative embodiment. As the operation begins, the power management mechanism receives signals comprising information from the virtualization layer in the virtualized environment (step 602). The power management mechanism determines whether the information is for either the creation or the destruction of a logical partition (step 604). If at step 604 the information is for either the creation or the destruction of a logical partition, the power management mechanism determines whether the information is for the creation or the destruction of a logical partition (step 606). If at step 606 the information is for the creation of a logical partition, the power management mechanism adds the new LPARname of the logical partition and physical processing units associated with the logical partition to a list of logical partitions that the power management mechanism will apply DPPM policies to (step 608).

The power management mechanism initializes the processing units associated with the logical partition to a specified performance level associated with the logical partition specified in the DPPM policy settings associated with the logical partition (step 610). Once the processing units are running at the specified performance level, the power management mechanism sends a signal to the virtualization layer that informs the virtualization layer that the processing units associated with the logical partition are successfully running at the specified performance level associated with the current DPPM policy (step 612). The power management mechanism then begins to monitor the active processing units for all logical partitions (step 614). During the monitoring, the power management mechanism collects data such as operational frequency, processing unit utilization, and power usage. At either predetermined times, periodic intervals, in response to a query, or the like, the power management mechanism sends partition level trending data such as average frequency, average utilization, average power usage, or the like to the active energy manager mechanism (step 616). The power management mechanism then determines if new information has been received from the virtualization layer (step 618). If at step 618 no new information has been received, then the operation returns to step 614. If at step 618 new information has been received, the operation returns to step 602 to receive the signals comprising the information.

If at step 606 the received information is for the destruction of a logical partition, the power management mechanism destroys all information associated with the specified logical partition (step 620), with the operation returning to step 602 thereafter to wait for the next receipt of information. If at step 604 the information is a new DPPM policy for the logical partition, then the power management mechanism adjusts parameters associated with the processing units based on the new DPPM policy allocated to the logical partition (step 622), with the operation returning to step 614 thereafter.

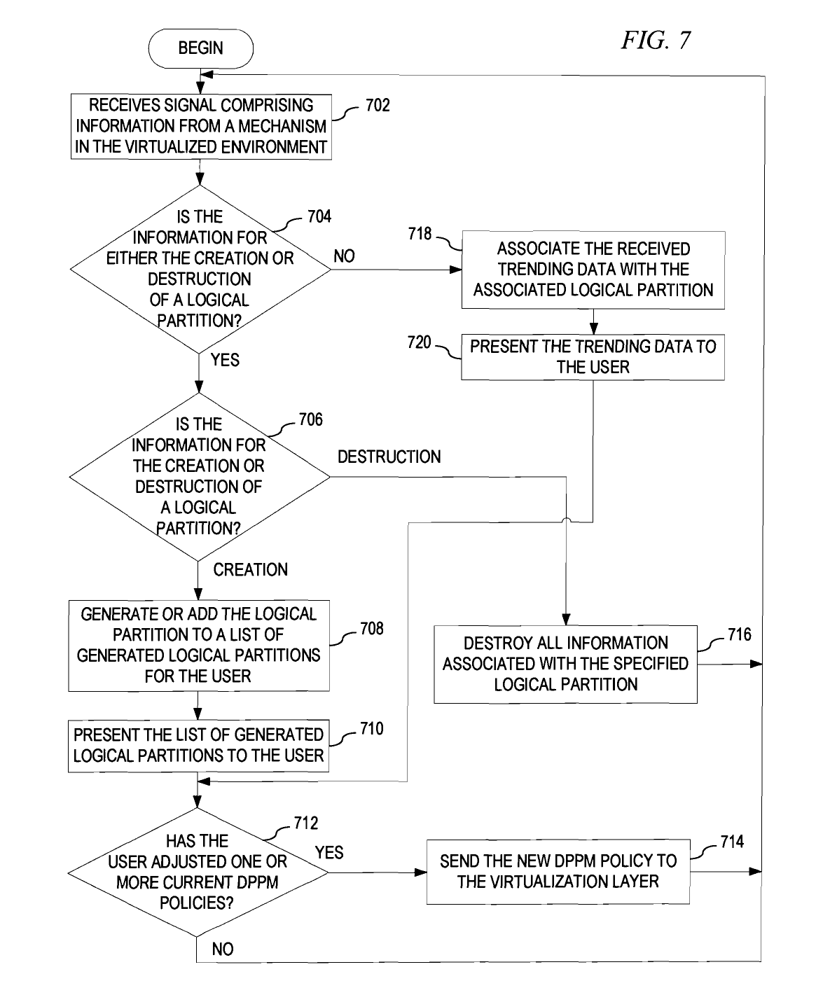

FIG. 7 depicts an example of the operation performed by an active energy manager mechanism in a virtualized environment in accordance with an illustrative embodiment. As the operation begins, the active energy manager mechanism receives signals comprising information from a mechanism in the virtualized environment (step 702). The active energy manager mechanism determines whether the information is for either the creation or the destruction of a logical partition (step 704). If at step 704 the information is for either the creation or the destruction of a logical partition, the active energy manager mechanism determines whether the information is for the creation or the destruction of a logical partition (step 706). If at step 706 the information is for the creation of a logical partition, the active energy manager mechanism generates or adds to a list of generated logical partitions for the user (step 708), The active energy manager mechanism then presents the list of generated logical partitions to the user that requested the generation of the logical partitions (step 710).

The active energy manager mechanism then determines whether the user has adjusted one or more current DPPM policies associated with one or more associated logical partitions generated for the user (step 712). If at step 712 no adjustments are made by the user, then the operation returns to step 702. If at step 712 the user makes adjustments to one or more current DPPM policies associated with one or more associated logical partitions, then the active energy manager mechanism sends the new DPPM policy to the virtualization layer (step 714), with the operation returning to step 702 thereafter to wait for the next receipt of information.

If at step 706 the received information is for the destruction of a logical partition, the active energy manager mechanism destroys all information associated with the specified logical partition (step 716), with the operation returning to step 702 thereafter to wait for the next receipt of information. If at step 704 the information is trending data from the power management mechanism, the active energy manager mechanism associates the received trending data with the associated logical partition (step 718). The active energy manager mechanism then presents the trending data to the user (step 720) and the operation proceeds to step 712.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for controlling power management policies on a per partition basis in a virtualized environment. In the illustrative embodiments, a logical interaction is provided between four key components: a mechanism that can set DPPM policies on a per partition basis, a mechanism that knows about partitions and associated DPPM policies per partition, a mechanism that generates or destroys partitions, and a mechanism that is responsible for making pools of physical cores available to run partitions. Using this logical interaction between the four key components, power management policies may be controlled on a per partition basis.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for controlling power management policies on a per logical partition basis, the method comprising:
receiving, by a power management mechanism in the data processing system, a notification that the logical partition has been generated, a set of processing units associated with the logical partition, and a current power management policy to be implemented for the logical partition;
adding, by the power management mechanism, the logical partition and the set of processing units to a list of logical partitions;
initializing, by the power management mechanism, the set of processing units based on settings for the set of processing units in the current power management policy; and
notifying, by the power management mechanism, a virtualization mechanism in the data processing system that the set of processing units are running at a specified performance level as specified by the settings for the set of processing units in the current power management policy in order for the logical partition to start executing tasks on the set of processing units.

2. The method of claim 1, further comprising:
monitoring, by the power management mechanism, the set of processing units for at least one of operational frequency, processing unit utilization, or power usage; and
sending, by the power management mechanism, trending data for the set of processing units to an active energy manager mechanism in the data processing system, wherein the trending data comprises at least one of an average operational frequency, an average processing unit utilization, average instructions per second rates, memory hierarchy latency characteristics, or an average power usage.

3. The method of claim 1, further comprising:
receiving, by the power management mechanism, a new power management policy to be implemented for the logical partition;
adjusting, by the power management mechanism, parameters for the set of processing units based on settings for the set of processing units in the new power management policy; and
notifying, by the power management mechanism, the virtualization mechanism in the data processing system that the set of processing units are running at a specified performance level as specified by the settings for the set of processing units in the new power management policy.

4. The method of claim 3, wherein the new power management policy is received from a user via an active energy manager mechanism that presents trending data to the user, wherein the trending data comprises at least one of an average operational frequency, an average processing unit utilization, or an average power usage, and wherein the new power management policy is submitted by the user in response to the trending data.

5. The method of claim 1, wherein the current power management policy is at least one of a default policy or a policy specified by the user.

6. The method of claim 1, wherein the power management mechanism receives the notification that the logical partition has been generated, the set of processing units associated with the logical partition, and the current power management policy to be implemented for the logical partition via the virtualization mechanism, and wherein the virtualization mechanism:
receives a notification that a logical partition has been generated from a partition creation mechanism in the data processing system;
sends a notification to the power management mechanism indicating that the logical partition has been generated, the number of processing units associated with the logical partition, and the current power management policy to be implemented for the logical partition; and
sends a notification to an active energy manager mechanism in the data processing system indicating that the logical partition has been generated.

7. The method of claim 6, wherein the partition creation mechanism generates the logical partition by the method comprising:
receiving, by the partition creation mechanism, a request to generate the logical partition;
identifying, by the partition creation mechanism, a type of logical partition to be generated and a number of processing units to be associated with the logical partition thereby forming the set of processing units;
determining, by the partition creation mechanism, whether the power management policy is specified in the request for the logical partition;
generating, by the partition creation mechanism, the logical partition based on the type logical partition;
allocating, by the partition creation mechanism, the set of processing units to the logical partition; and
notifying, by the partition creation mechanism, the virtualization mechanism that the logical partition has been generated, the number of processing units in the set of processing units, and whether the power management policy was specified.

8. A computer program product comprising a computer readable storage medium having a computer readable program stored therein, wherein the computer readable program, when executed on a computing device, causes the computing device to:
receive a notification that the logical partition has been generated, a set of processing units associated with the logical partition, and a current power management policy to be implemented for the logical partition;
add the logical partition and the set of processing units to a list of logical partitions;
initialize the set of processing units based on settings for the set of processing units in the current power management policy; and
notify a virtualization mechanism in the computing device that the set of processing units are running at a specified performance level as specified by the settings for the set of processing units in the current power management policy in order for the logical partition to start executing tasks on the set of processing units.

9. The computer program product of claim 8, wherein the computer readable program further causes the computing device to:
monitor the set of processing units for at least one of operational frequency, processing unit utilization, or power usage; and
send trending data for the set of processing units to an active energy manager mechanism in the data processing system, wherein the trending data comprises at least one of an average operational frequency, an average processing unit utilization, average instructions per second rates, memory hierarchy latency characteristics, or an average power usage.

10. The computer program product of claim 9, wherein the computer readable program further causes the computing device to:
receive a new power management policy to be implemented for the logical partition;
adjust parameters for the set of processing units based on settings for the set of processing units in the new power management policy; and
notify the virtualization mechanism in the data processing system that the set of processing units are running at a specified performance level as specified by the settings for the set of processing units in the new power management policy.

11. The computer program product of claim 10, wherein the new power management policy is received from a user via an active energy manager mechanism that presents trending data to the user, wherein the trending data comprises at least one of an average operational frequency, an average processing unit utilization, or an average power usage, and wherein the new power management policy is submitted by the user in response to the trending data.

12. The computer program product of claim 9, wherein the current power management policy is at least one of a default policy or a policy specified by the user.

13. The computer program product of claim 9, wherein the computer program product receives the notification that the logical partition has been generated, the set of processing units associated with the logical partition, and the current power management policy to be implemented for the logical partition via the virtualization mechanism, and wherein the computer readable program further causes the computing device to:
receive a notification that a logical partition has been generated from a partition creation mechanism in the data processing system;
send a notification to the power management mechanism indicating that the logical partition has been generated, the number of processing units associated with the logical partition, and the current power management policy to be implemented for the logical partition; and
send a notification to an active energy manager mechanism in the data processing system indicating that the logical partition has been generated.

14. The computer program product of claim 13, wherein the computer readable program generates the logical partition by further causing the computing device to:
receive a request to generate the logical partition;
identify a type of logical partition to be generated and a number of processing units to be associated with the logical partition thereby forming the set of processing units;
determine whether the power management policy is specified in the request for the logical partition;
generate the logical partition based on the type logical partition;
allocate the set of processing units to the logical partition; and
notify the virtualization mechanism that the logical partition has been generated, the number of processing units in the set of processing units, and whether the power management policy was specified.

15. An apparatus, comprising:
a processor; and
a memory coupled to the processor, wherein the memory comprises instructions which, when executed by the processor, cause the processor to:
receive a notification that the logical partition has been generated, a set of processing units associated with the logical partition, and a current power management policy to be implemented for the logical partition;
add the logical partition and the set of processing units to a list of logical partitions;
initialize the set of processing units based on settings for the set of processing units in the current power management policy; and
notify a virtualization mechanism in the computing device that the set of processing units are running at a specified performance level as specified by the settings for the set of processing units in the current power management policy in order for the logical partition to start executing tasks on the set of processing units.

16. The apparatus of claim 15, wherein the instructions further cause the processor to:
monitor the set of processing units for at least one of operational frequency, processing unit utilization, or power usage; and
send trending data for the set of processing units to an active energy manager mechanism in the data processing system, wherein the trending data comprises at least one of an average operational frequency, an average processing unit utilization, average instructions per second rates, memory hierarchy latency characteristics, or an average power usage.

17. The apparatus of claim 15, wherein the instructions further cause the processor to:
receive a new power management policy to be implemented for the logical partition;
adjust parameters for the set of processing units based on settings for the set of processing units in the new power management policy; and
notify the virtualization mechanism in the data processing system that the set of processing units are running at a specified performance level as specified by the settings for the set of processing units in the new power management policy.

18. The apparatus of claim 17, wherein the new power management policy is received from a user via an active energy manager mechanism that presents trending data to the user, wherein the trending data comprises at least one of an average operational frequency, an average processing unit utilization, or an average power usage, and wherein the new power management policy is submitted by the user in response to the trending data.

19. The apparatus of claim 15, wherein the apparatus receives the notification that the logical partition has been generated, the set of processing units associated with the logical partition, and the current power management policy to be implemented for the logical partition via the virtualization mechanism, and wherein the instructions further cause the processor to:
receive a notification that a logical partition has been generated from a partition creation mechanism in the data processing system;
send a notification to the power management mechanism indicating that the logical partition has been generated, the number of processing units associated with the logical partition, and the current power management policy to be implemented for the logical partition; and
send a notification to an active energy manager mechanism in the data processing system indicating that the logical partition has been generated.

20. The apparatus of claim 19, wherein the instructions generate the logical partition by further causing the processor to:
receive a request to generate the logical partition;
identify a type of logical partition to be generated and a number of processing units to be associated with the logical partition thereby forming the set of processing units;
determine whether the power management policy is specified in the request for the logical partition;
generate the logical partition based on the type logical partition;
allocate the set of processing units to the logical partition; and
notify the virtualization mechanism that the logical partition has been generated, the number of processing units in the set of processing units, and whether the power management policy was specified.
